(19) United States
(12) Patent Application Publication
(10) Pub. No.: US 2010/0010717 A1
(43) Pub. Date: Jan. 14, 2010

(54) CONTROL DEVICE AND CONTROL METHOD FOR AUTOMATIC TRANSMISSION

(75) Inventor: Yasuhiro Maeda, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi, Aichi-ken (JP)

(21) Appl. No.: 12/439,367

(22) PCT Filed: Mar. 6, 2008
(86) PCT No.: PCT/IB2008/000900

§ 371 Date: Feb. 27, 2009

(30) Foreign Application Priority Data
Mar. 7, 2007 (JP) 2007-057412

(51) Int. Cl. G06F 19/00

(52) U.S. Cl. 701/56

(57) ABSTRACT

A control device executes a gear change control based on a first gear change map, in which the accelerator operation amount and the vehicle speed are used as parameters to define gear change timings, if a brake device is not actuated while the vehicle is running, and executes the gear change control based on a second gear change map, in which the brake actuation pressure and the vehicle speed are used as parameters to define gear change timings that positively utilize engine braking, if the brake device is actuated while the vehicle is running. The control device allows an automatic transmission to execute the gear change control in which engine braking is positively utilized according to conditions, contributing to diversified gear change control.

### BACKGROUND OF THE INVENTION

1. Field of the Invention

The present invention relates to a control device and a control method for an automatic transmission that automatically select a gear of the automatic transmission according to running conditions of a vehicle.

2. Description of the Related Art

In general, an electronic control unit (ECU) for controlling the gear change operation of an electronically controlled automatic transmission having a plurality of gears uses a gear change map including a downshift gear change line and an upshift gear change line for selecting an optimum gear using parameters representing the required driving force and the vehicle speed such as, the accelerator operation amount and the rotational speed of an output shaft of the automatic transmission, respectively.

Some gear change maps (in which the vertical axis represents the accelerator operation amount and the horizontal axis represents the vehicle speed) have a coast down gear change line in addition to the normal upshift gear change line (see Japanese Patent Application Publication No. 2003-269601 (JP-A-2003-269601), for example).

The normal upshift gear change line is shifted to the high speed side with respect to the coast down gear change line. To put it in the other way, the coast down gear change line is shifted to the low speed side with respect to the normal upshift gear change line.

In this related art, when an accelerator pedal is not depressed (i.e. a throttle valve is substantially closed) and a brake pedal is not depressed while the vehicle is traveling in a relatively high speed range, the normal upshift gear change line is used to immediately upshift in order to reduce the engine speed. If the brake pedal is depressed, the coast down gear change line is used to cancel the immediate upshift operation.

In another gear change control of the automatic transmission, a normal travel gear change map is used when the driver desires acceleration, and a downhill travel gear change map is used when the vehicle is running downhill (see Japanese Patent Application Publication No. 9-72412 (JP-A-9-72412)).

In the conventional art disclosed in JP-A-2003-269601 cited above, a single gear change map is used, and the normal upshift gear change line and the coast down gear change line in the gear change map use the required driving force such as an accelerator operation amount and the vehicle speed—not the required braking force such as a brake actuation pressure and the vehicle speed—as parameters to determine gear change timings. In other words, the art described in JP-A-2003-269601 does not have a technical concept to positively utilize engine braking.

In JP-A-9-72412, two types of gear change maps—for normal running and for downhill running are used. Both of these maps, however, have been prepared using the accelerator operation amount and the vehicle speed—not the required braking force such as a brake actuation pressure and the vehicle speed—as parameters to determine gear changes timings for upshifts and downshifts.

Therefore, engine braking cannot be positively utilized in this conventional art, because a downshift is not executed before the vehicle speed is decreased to cross the downshift gear change line in the gear change map, even if the driver intends to control deceleration by, for example, depressing the brake pedal. In addition, when the driver depresses the brake pedal while the vehicle is running steep downhill, for example, the vehicle speed is not necessarily reduced but rather may be increased depending on the gradient. In such a case, if the vehicle speed is increased to cross the upshift gear change line, an upshift is executed to disable engine braking, which may result in insufficient deceleration.

### SUMMARY OF THE INVENTION

The present invention provides a control device and a control method for an automatic transmission that executes gear change controls in which engine braking is positively utilized according to conditions, contributing to diversified gear change control.

One aspect of the present invention provides a control device for an automatic transmission, that executes a gear change control based on a first gear change map, in which a required driving force and a vehicle speed are used as parameters to define a gear change timing, if a brake device is not actuated while the vehicle is running, and that executes the gear change control based on a second gear change map, in which a required braking force and the vehicle speed are used as parameters to define a gear change timing that positively utilizes engine braking, if the brake device is actuated while the vehicle is running. The required driving force may include an accelerator operation amount and the required braking force may include a brake actuation pressure.

Another aspect of the present invention provides a control method for an automatic transmission. The control method includes:

executing a gear change control of the automatic transmission based on a first gear change map, in which a required driving force and a vehicle speed are used as parameters to define a gear change timing, if a brake device is not actuated while the vehicle is running; and

executing the gear change control of the automatic transmission based on a second gear change map, in which a required braking force and the vehicle speed are used as parameters to define a gear change timing that positively utilizes engine braking, when the brake device is actuated while the vehicle is running.

A further aspect of the present invention provides a control device for an automatic transmission. The automatic transmission control device includes: a vehicle speed sensor that detects a vehicle speed; a required driving force sensor that detects a required driving force; a required braking force sensor that detects a required braking force; a storage device that stores a first gear change map, in which the required driving force and the vehicle speed are used as parameters to define a gear change timing, and a second gear change map, in which the required braking force and the vehicle speed are used as parameters to define a gear change timing that positively utilizes engine braking; and a management device that executes the gear change control of the automatic transmission based on an output from the vehicle speed sensor, the required driving force sensor, and the required braking force sensor. In the control device for an automatic transmission provided, the management device collates an actual required driving force and an actual vehicle speed with the first gear change map in the storage device to execute the gear change control if a brake device is not actuated while the vehicle is running, and collates an actual required braking force and the actual vehicle speed with the second gear change map in the storage device to execute the gear change control if the brake device is actuated while the vehicle is in motion.

A still further aspect of the present invention provides a control method for an automatic transmission. The control method includes: detecting the vehicle speed; detecting the required driving force; detecting the required braking force; storing a first gear change map, in which the required driving force and the vehicle speed are used as parameters to define a gear change timing, and a second gear change map, in which the required braking force and the vehicle speed are used as parameters to define a gear change timing that positively utilizes engine braking; executing a gear change control of the automatic transmission based on the detected vehicle speed, required driving force, and required braking force; and collating an actual required driving force and an actual vehicle speed with the stored first gear change map to execute the gear change control of the automatic transmission if a brake device is not actuated while the vehicle is in motion, and collating the actual required driving force and the actual vehicle speed with the stored second gear change map to execute the gear change control of the automatic transmission if the brake device is actuated while the vehicle is in motion.

If the accelerator operation amount is being adjusted without the brake pedal depressed while the vehicle is in motion, for example, the driver of the vehicle is considered to be attempting natural deceleration or acceleration with some required driving force in mind. On the other hand, if the brake pedal is depressed while the vehicle is in motion, for example, the driver of the vehicle is considered to be intending to control deceleration with some required braking force in mind.

According to the control device and the control method for an automatic transmission described above, the gear change control may be diversified by selectively using either the first or second gear change map by taking into account the driver's intention while driving the vehicle.

For example, in circumstances where the driver of the vehicle is attempting deceleration or acceleration normally, the first gear change map is used to enable normal gear change control, which is effective to improve the acceleration performance and fuel economy, for example. In addition, in circumstances where the driver of the vehicle intends to control deceleration of the vehicle, for example, the second gear change map is used to enable gear change control that positively utilizes engine braking, for example.

In view of the above, the first gear change map may define normal gear change timings that are effective to improve the acceleration performance and fuel economy, and that the second gear change map define gear change timings that positively utilize engine braking.

Also, in the control device and the control method for an automatic transmission, the second gear change map includes an upshift gear change line and a downshift gear change line for each gear, the upshift gear change line that is shaped to permit an upshift at a higher vehicle speed as the brake actuation pressure increases and the downshift gear change line that is shaped to permit a downshift at a higher vehicle speed as the brake actuation pressure increases.

According to the control device and the control method for an automatic transmission described above, if relatively strong deceleration, for example by actuation of the brake device, is desired while traveling at a relatively high speed, for example, it is possible to immediately downshift in order to positively apply engine braking by using the downshift gear change line of the second gear change map. In addition, if the vehicle speed increases even when the brake device is actuated while the vehicle is traveling down a steep hill, it is possible to prevent an unnecessary upshift in order to avoid engine braking from being disabled by using the upshift gear change line of the second gear change map.

As described above, during execution of gear change control using the second gear change map, it is possible to positively utilize engine braking, and hence to suitably respond to the driver's intention to decelerate the vehicle by actuating the brake device.

### BRIEF DESCRIPTION OF THE DRAWINGS

The features, advantages, and technical and industrial significance of this invention will be better understood by reading the following detailed description of preferred embodiments of the invention, when considered in connection with the accompanying drawings, in which:

FIG. 1 is a schematic diagram showing the configuration of a powertrain of a vehicle to which a control device for an automatic transmission in accordance with the present invention is applied;

FIG. 2 is a skeleton diagram showing an example of the gear change mechanism in the automatic transmission of FIG. 1;

FIG. 3 is an engagement table of the clutches C1 to C4, the brakes B1 to B4, and the one-way clutches F0 to F3 at each gear of the gear change mechanism of FIG. 2;

FIG. 4 is a schematic diagram showing the configuration of the transmission control device of FIG. 1;

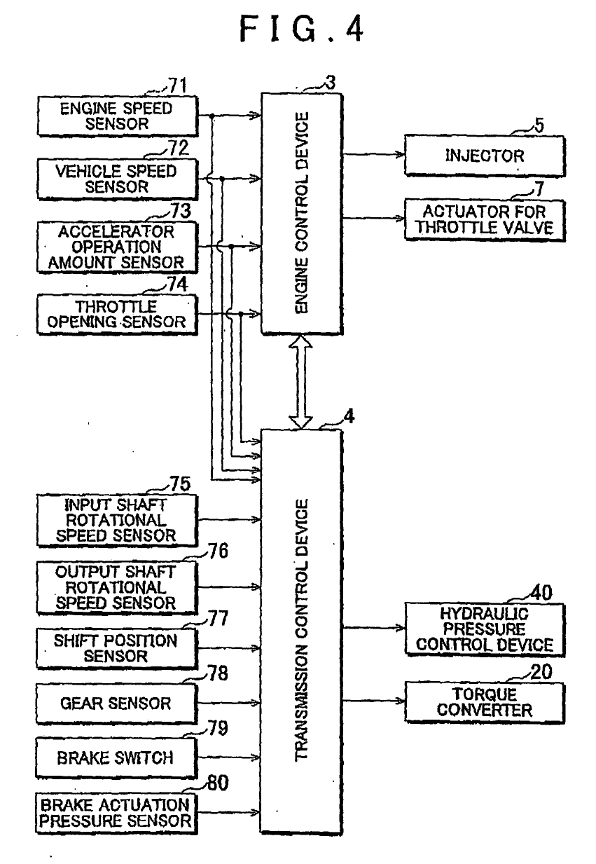

FIG. 5 is a diagram showing a gear change map for use to describe the operation of the transmission control device of FIG. 4; and

FIG. 6 is a flowchart for use to describe the operation of the transmission control device of FIG. 4.

### DETAILED DESCRIPTION OF THE EMBODIMENTS

In the following description and the accompanying drawings, the present invention will be described in greater detail with reference to example embodiments.

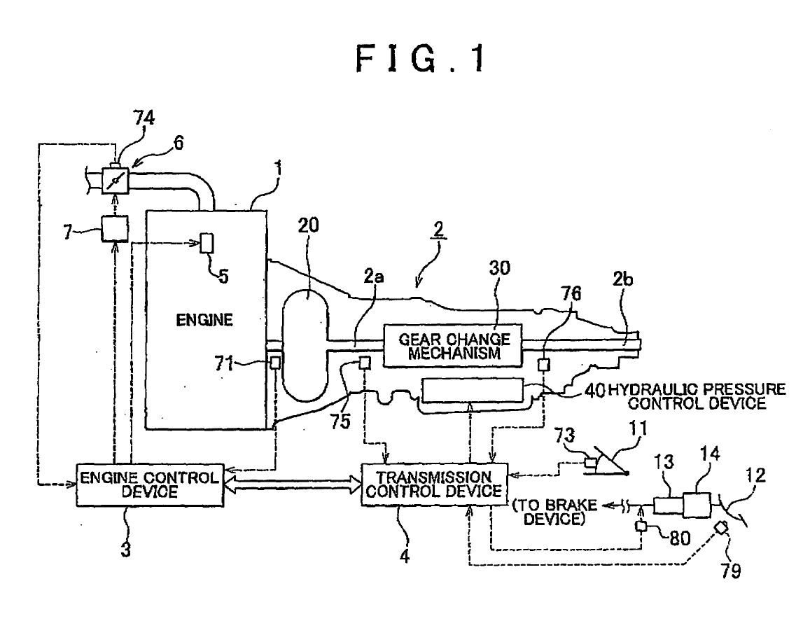

Before describing the characteristics of the present invention, the outline of an automatic transmission to which the present invention is applied will be described with reference to FIG. 1 to FIG. 3.

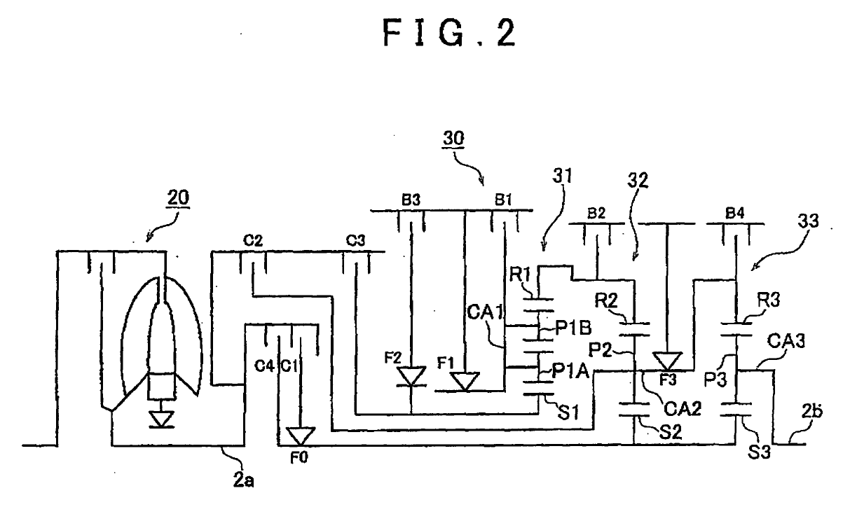

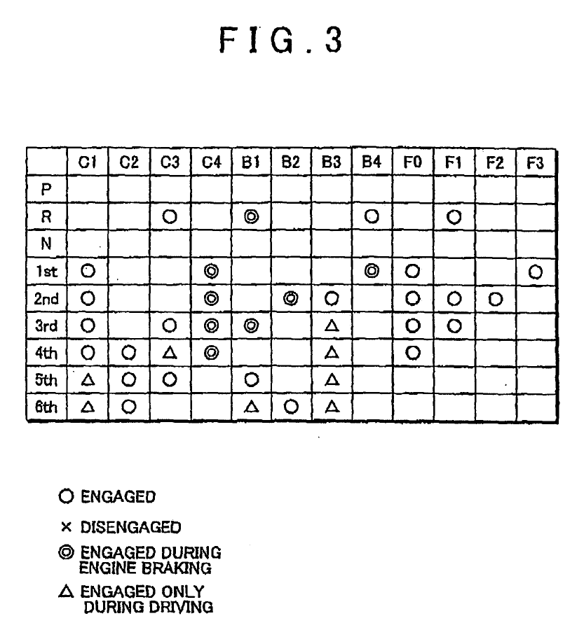

FIG. 1 is a schematic diagram showing the configuration of a powertrain of a vehicle to which the present invention is applied. FIG. 2 is a skeleton diagram showing an example of the gear change mechanism in the automatic transmission of FIG. 1. FIG. 3 is an engagement table of respective clutches and brakes at each gear of the gear change mechanism of FIG. 2.

In the figures, reference numeral 1 denotes an engine, 2 an automatic transmission, 3 an engine control device, and 4 a transmission control device.

The engine 1 is a gasoline engine, for example. The engine 1 generates a rotational force by burning an air-fuel mixture obtained by mixing air drawn from outside and fuel injected from an injector 5 at an appropriate ratio. An electronically controlled throttle valve 6 (electronic throttle system) adjusts the amount of air that is drawn into the engine 1 (target intake air amount).

The throttle valve 6 is driven by an electric actuator 7. The throttle opening is appropriately adjusted by driving the actuator 7 based on the amount of depression of an accelerator pedal 11 (accelerator operation amount) and conditions required for control. The injector 5 and the actuator 7 are controlled by the engine control device 3. The rotational speed of the engine 1, in other words, the rotational speed of a crankshaft (output shaft) of the engine 1, is detected by an engine speed sensor 71. The opening of the throttle valve 6 (throttle opening) is detected by a throttle opening sensor 74.

The automatic transmission 2 outputs the rotational force input from the engine 1 after changing the speed thereof. The automatic transmission 2 is configured to include, as its main components, a torque converter 20, a gear change mechanism 30, and a hydraulic pressure control device 40. Because the respective components of the automatic transmission 2 have commonly known configurations, detailed illustrations and descriptions of such components will be omitted herein.

As shown in FIG. 2, the gear change mechanism 30 includes, as its main components, a first planetary gear set 31, a second planetary gear set 32, a third planetary gear set 33, clutches C1 to C4, brakes B1 to B4, and one-way clutches F0 to F3. The gear change mechanism 30 has six forward gears and one reverse gear.

The first planetary gear set 31 is a double pinion planetary gear mechanism. The first planetary gear set 31 includes a sun gear S1, a ring gear R1, a plurality of inner pinions P1A, a plurality of outer pinions P1B, and a carrier CA1.

The second planetary gear set 32 is a single pinion planetary gear mechanism. The second planetary gear set 32 includes a sun gear S2, a ring gear R2, a plurality of pinion gears P2, and a carrier CA2.

The third planetary gear set 33 is a single pinion planetary gear mechanism. The third planetary gear set 33 includes a sun gear S3, a ring gear R3, a plurality of pinion gears P3, and a carrier CA3.

The clutches C1 to C4 and the brakes B1 to B4 are each a multi-plate friction engagement device of a wet type that utilizes the viscosity of oil.

The rotational speed of an input shaft 2a of the automatic transmission 2 is detected by an input shaft rotational speed sensor 75, and the rotational speed of an output shaft 2b is detected by an output shaft rotational speed sensor 76.

The hydraulic pressure control device 40 has a linear solenoid valve, an on-off solenoid valve, and so on (not shown) for individually engaging and disengaging the clutches C1 to C4 and the brakes B1 to B4 in the gear change mechanism 30. An appropriate gear (first to sixth gear) is established by individually engaging and disengaging the clutches C1 to C4 and the brakes B1 to B4 based on a hydraulic pressure command signal (solenoid control signal) input from the transmission control device 4.

The conditions required for each gear to be established in the gear change mechanism 30 are shown in FIG. 3.

FIG. 3 is an engagement table showing the engagement and disengagement of the clutches C1 to C4, the brakes B1 to B4, and the one-way clutches F0 to F3 for each gear of the gear change mechanism. In this engagement table, the single circular mark represents “engaged,” the X mark represents “disengaged,” the double circular mark represents “engaged during engine braking,” and the triangular mark represents “engaged only during driving.”

The clutch C1 is called a “forward clutch (input clutch).” As shown in the engagement table of FIG. 3, the clutch C1 is always engaged to establish a gear to allow the vehicle to move forward when not in the parking position (P), the reverse position (R), or the neutral position (N), that is, when in the drive position (D), for example.

Although not shown in detail, both the engine control device 3 and the transmission control device 4 are a commonly known electronic control unit (ECU), and include a CPU, a ROM, a RAM, and a backup RAM.

The ROM stores various control programs, maps to be referenced when such control programs are executed, and so on. The CPU executes operations based on the control programs and the maps stored in the ROM. The RAM is a memory for temporarily storing the results of the operations in the CPU, data input from respective sensors, and so on. The backup RAM is a nonvolatile memory for storing data to be saved such as when the engine 1 is stopped.

The engine control device 3 and the transmission control device 4 are connected so as to be able to exchange information required for control of the engine 1 and gear change control of the automatic transmission 2 between each other.

The engine control device 3 mainly detects the operating state of the engine 1 based on information input from various sensors described below, and executes overall control of the operation of the engine 1 by adjusting the fuel injection amount, the intake air amount, and so on using the injector 5, the actuator 7 for the throttle valve 6, and so on.

At least the engine speed sensor 71, a vehicle speed sensor 72, an accelerator operation amount sensor, and the throttle valve opening sensor 74 are connected to the input interface of the engine control device 3.

The transmission control device 4 mainly controls respective components of the torque converter 20 and the hydraulic pressure control device 40 based on the information input from various sensors described below to establish an appropriate gear, in other words, power transmission path, in the gear change mechanism 30.

At least an input shaft rotational speed sensor 75, an output shaft rotational speed sensor 76, a shift position sensor 77 that detects the shift position of the automatic transmission 2, a gear sensor 78 that detects the gear being established in the automatic transmission 2, a brake switch 79 that detects whether the brake pedal 12 is being depressed by the driver of the vehicle, and a brake actuation pressure sensor 80 that detects the pressure of hydraulic oil discharged from a brake master cylinder 13 according to a depression of the brake pedal 12, in addition to the engine speed sensor 71, the vehicle speed sensor 72, the accelerator operation amount sensor 73, and the throttle opening sensor 74 are connected to the input interface of the transmission control device 4.

When the brake pedal 12 is depressed, the brake depression force is amplified by a brake booster 14 so that the brake master cylinder 13 applies an appropriate actuation pressure to a brake device (not shown) for each wheel. The brake device is a commonly known disc brake, drum brake, or the like.

The vehicle speed sensor 72, the accelerator operation amount sensor 73, and the brake actuation pressure sensor 80 described above correspond to the vehicle speed sensor, the required driving force sensor, and the required braking force sensor, respectively, of the present invention.

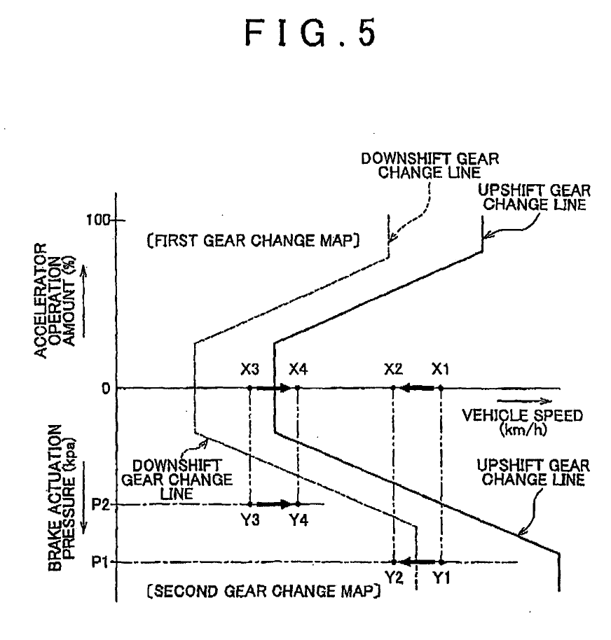

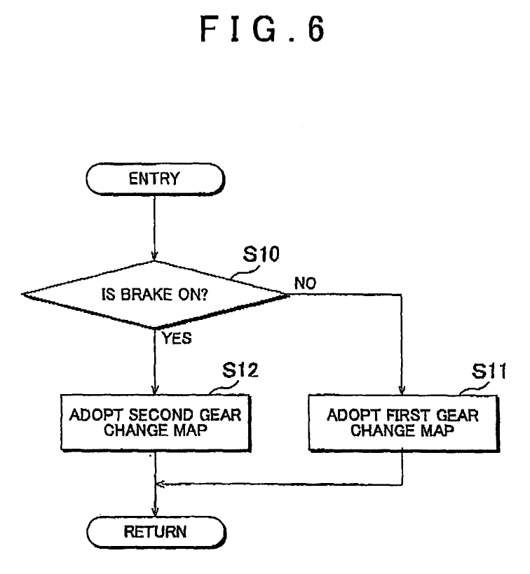

A detailed description will next be made of the characteristics of the present invention with reference to FIG. 5 and FIG. 6.

The present invention enables finer gear change control by taking into account the driver's intention while driving the vehicle.

In particular, if the brake device is actuated while the vehicle is running, for example, a downshift is immediately performed to positively apply engine braking. In addition, if the vehicle speed increases even when the brake device is actuated while the vehicle is running steep downhill, an unnecessary upshift is prevented to avoid engine braking from being disabled.

For this purpose, a first gear change map and a second gear change map that allow selection of a suitable gear of the automatic transmission 2 are stored in the ROM of the transmission control device 4.

In the first gear change map, the accelerator operation amount and the vehicle speed are used as parameters to define timings of normal gear changes that are effective to improve the acceleration performance and fuel economy, for example.

In the second gear change map, the brake actuation pressure and the vehicle speed are used as parameters to define timings of special gear changes that positively utilize engine braking.

The first gear change map and the second gear change map may be presented in the form schematically shown in FIG. 5.

Specifically, in FIG. 5, the horizontal axis represents the vehicle speed, the portion of the vertical axis above the horizontal axis represents the accelerator operation amount, and the portion of the vertical axis below the horizontal axis represents the brake actuation pressure. The upper and lower regions with respect to the horizontal axis correspond to the first gear change map and the second gear change map, respectively.

Because the horizontal axes of the first gear change map and the second gear change map both represent the vehicle speed and are on the same scale, the two maps are shown in a single drawing, namely FIG. 5.

Both the gear change maps have a number of upshift gear change lines and downshift gear change lines corresponding to the number of gears of the automatic transmission 2, because an upshift gear change line and a downshift gear change line are associated with each gear. In FIG. 5, however, only one upshift gear change line (indicated by the solid line) and one downshift gear change line (indicated by the broken line) are shown for ease of understanding.

In this embodiment, the shape of the upshift gear change line and the downshift gear change line in the second gear change map are determined by shifting only a part of the upshift gear change line and the downshift gear change line in a high vehicle speed range of the first gear change map to the high vehicle speed side. The amount of this shifting is empirically determined.

In other words, the upshift gear change line of the second gear change map is shaped to permit an upshift at a higher vehicle speed relative to that of the first gear change map as the brake actuation pressure is higher, and the downshift gear change line of the second gear change map is shaped to permit a downshift at a higher vehicle speed relative to that of the first gear change map as the brake actuation pressure is higher.

The gear change control executed by the transmission control device 4 will now be described with reference to the flowchart of FIG. 6. Each operation of steps in this flowchart is performed at regular intervals.

In step 10, it is determined whether the brake is being applied, in other words, whether the brake pedal 12 is being depressed. This determination may be made by checking whether the signal input from the brake switch 79 indicates “on” or “off.”

If the brake is off, a negative determination is made in step S10, and the operation proceeds to step S11. If the brake is on, a positive determination is made in step S10, and the operation proceeds to step S12.

In step S11, the first gear change map, shown in the upper half of FIG. 5, is adopted. Then, although not shown, gear change control is executed using the first gear change map adopted in step S11 of the gear change control routine.

In step S12, the second gear change map, shown in the lower half of FIG. 5, is adopted. Then, although not shown, gear change control is executed using the second gear change map adopted in step S12 of the gear change control routine.

The basic operation of the gear change control executed by the transmission control device 4 will now be described.

In circumstances where the vehicle is in a certain gear, and the vehicle speed is decreased to cross the downshift gear change line corresponding to the current gear in either one of the first and second gear change maps, a downshift to a target gear lower than the current gear is executed by outputting to the hydraulic pressure control device 40 of the automatic transmission 2 a command signal (solenoid control signal) commanding such a gear change.

In the same circumstances, if the vehicle speed is decreased to such a lesser degree as not to cross the downshift gear change line corresponding to the current gear in either one of the first and second gear change maps, the current gear is held by outputting to the hydraulic pressure control device 40 of the automatic transmission 2 a command signal (solenoid control signal) commanding that the target gear be held at the current gear.

Next, the gear change control executed by the transmission control device 4 will be described and compared with the conventional art.

If the accelerator is not operated and the brake is applied while the vehicle is moving at a relatively high speed, it may be interpreted that the driver desires relatively immediate deceleration by positively applying engine braking.

When the vehicle speed is decreased in such circumstances, the downshift gear change line of the second gear change map based on the brake actuation pressure and the vehicle speed is used in this embodiment, in contrast to a downshift gear change line of a gear change map based on the accelerator operation amount and the vehicle speed (corresponding to the first gear change map of this embodiment) used in the conventional art.

Conventionally, such a decrease in the vehicle speed in the above circumstances corresponds to, for example, movement from the point X1 to the point X2 on the horizontal axis (at an accelerator operation amount of 0%) in the first gear change map shown in FIG. 5, which does not cross the downshift gear change line of the first gear change map.

Therefore, it results in an insufficient engine braking, because the gear is held in the current gear. Thus, the gear change control in the conventional art is not suitable for the above circumstances.

In contrast, in this embodiment, such a decrease in vehicle speed instead corresponds to, for example, movement from the point Y1 to the point Y2 on the line at a brake actuation pressure of P1 (see the dashed line) in the second gear change map shown in FIG. 5, which crosses the downshift gear change line of the second gear change map.

Therefore, the transmission downshifts from the current gear to a lower gear. This advantageously result in application of engine braking stronger than that in a conventional transmission.

Alternatively, if the accelerator is not operated and the brake is applied while the vehicle is moving down a steep incline, the thrust of the vehicle may be so dominant that the vehicle speed is not decreased but rather increased.

When the vehicle speed is increased under such circumstances, the upshift gear change line of the second gear change map based on the brake actuation pressure and the vehicle speed is used in this embodiment, in contrast to an upshift gear change line of a gear change map based on the accelerator operation amount and the vehicle speed (corresponding to the first gear change map of this embodiment) conventionally used.

Conventionally, such an increase in the vehicle speed in the above circumstances corresponds to, for example, movement from the point X3 to the point X4 on the horizontal axis (at an accelerator operation amount of 0%) in the first gear change map shown in FIG. 5, which crosses the upshift gear change line of the first gear change map.

Therefore, the transmission upshifts from the current gear to a higher gear to disable engine braking. Thus, the conventional gear change control is not suitable for the above circumstances.

In contrast, according to this embodiment, such an increase in vehicle speed instead corresponds to, for example, movement from the point Y3 to the point Y4 on the line at a brake actuation pressure of P2 (see the dashed line) in the second gear change map shown in FIG. 5, which does not cross the upshift gear change line of the second gear change map.

Therefore, the current gear is held. This results in continued application of engine braking and hence gradually decreasing vehicle speed, in contrast with a conventional transmission, in which engine braking is disabled.

The transmission control device 4 functions as the automatic transmission control device of the present invention, and functions as the management device, or to perform gear change control of the automatic transmission based on the accelerator operation amount and the brake actuation pressure.

As has been described above, in this embodiment, the transmission control device 4 diversifies the gear change control of the automatic transmission 2 by selectively using either one of the first or second gear change map by taking into account the driver's intention while driving the vehicle.

For example, in circumstances where the driver is attempting natural deceleration or acceleration, the first gear change map is used to enable normal gear change control, which is effective to improve the acceleration performance and fuel economy.

On the other hand, in circumstances where the driver intends to control deceleration of the vehicle, the second gear change map is used to enable gear change control that positively utilizes engine braking.

Specifically, if relatively strong deceleration is desired while traveling in a relatively high speed range, as in the first circumstances described above, it is possible to downshift immediately in order to positively apply engine braking by using the downshift gear change line of the second gear change map. In addition, if the vehicle speed is not decreased but rather increased even when the brake device is actuated while the vehicle is traveling on a steep downhill, as in the second circumstances described above, it is possible to prevent an unnecessary upshift in order to avoid engine braking from being disabled by using the upshift gear change line of the second gear change map.

The present invention is not limited to the above embodiment, and may include all modifications and alterations that fall within the scope of the appended claims and their equivalents.

(1) While the brake actuation pressure is detected by the brake actuation pressure sensor 80 in the above embodiment, it may be detected based on the results of measuring the load applied to the brake pedal 12, for example.

(2) While the running speed of the vehicle is detected based on a signal output from the vehicle speed sensor 72 in the above embodiment, it may be calculated based on a signal output from the output shaft rotational speed sensor 76.

(3) While the gear being established in the automatic transmission 2 is detected by the gear sensor 78 in the above embodiment, it may also be obtained by calculating the rotational speed ratio (output rotational speed/input rotational speed) obtained from signals output from the input shaft rotational speed sensor 75 and the output shaft rotational speed sensor 76 and collating the calculated values with a gear conversion table stored in advance.

(4) While the gear change control is executed based on the accelerator operation amount and the brake actuation pressure in the above embodiment, it is not limited thereto but may be executed based on the throttle opening and the depression amount of the brake pedal, for example. That is, in the control device for an automatic transmission of the present invention, the gear change control may be executed based on the “required driving force” and the “required braking force.”

1. A control device for an automatic transmission comprising:
a controller that executes a gear change control in the automatic transmission based on a first gear change map, in which a required driving force and a vehicle speed are used as parameters to define a gear change timing, if a brake device is not actuated while the vehicle is in motion, and executes the gear change control based on a second gear change map, in which a required braking force and the vehicle speed are used as parameters to define a gear change timing that positively utilizes engine braking, if the brake device is actuated while the vehicle is in motion, wherein
the required driving force includes an accelerator operation amount and the required braking force includes a brake actuation pressure, and the second gear change map has an upshift gear change line and a downshift gear change line for each gear, the upshift gear change line is shaped to permit an upshift at a higher vehicle speed as the brake actuation pressure increases and the downshift gear change line is shaped to permit a downshift at a higher vehicle speed as the brake actuation increases.

2. A control device for an automatic transmission comprising:
a controller that executes a gear change control in the automatic transmission based on a first gear change map, in which a required driving force and a vehicle speed are used as parameters to define a gear change timing, if a brake device is not actuated while the vehicle is in motion, and executes the gear change control based on a second gear change map, in which a required braking force and the vehicle speed are used as parameters to define a gear change timing that positively utilizes engine braking, if the brake device is actuated while the vehicle is in motion, wherein
the second gear change map has an upshift gear change line and a downshift gear change line for each gear, the upshift gear change line is shaped to permit an upshift at a higher vehicle speed as the required braking force increases and the downshift gear change line is shaped to permit a downshift at a higher vehicle speed as the brake required braking force increases.

3. A control device for an automatic transmission, comprising:
a vehicle speed sensor;
a required driving force sensor;
a required braking force sensor;
a storage device that stores a first gear change map, in which the required driving force and the vehicle speed are used as parameters to define a gear change timing, and a second gear change map, in which the required braking force and the vehicle speed are used as parameters to define a gear change timing that positively utilizes engine braking; and
a management device that executes a gear change control of the automatic transmission based on an output from the vehicle speed sensor, the required driving force sensor, and the required braking force sensor, wherein
the management device collates an actual required driving force and the detected vehicle speed with the first gear change map in the storage device to execute the gear change control if a brake device is not actuated while the vehicle is in motion, and collates an actual required braking force and the detected actual vehicle speed with the second gear change map in the storage device to execute the gear change control if the brake device is actuated while the vehicle is in motion, wherein
the required driving force includes an accelerator operation amount and the required braking force includes a brake actuation pressure, and
the second gear change map has an upshift gear change line and a downshift gear change line for each gear, the upshift gear change line is shaped to permit an upshift at a higher vehicle speed as the brake actuation pressure increases and the downshift gear change line is shaped to permit a downshift at a higher vehicle speed as the brake actuation increases.

4. A control device for an automatic transmission, comprising:
a vehicle speed sensor;
a required driving force sensor;
a required braking force sensor;
a storage device that stores a first gear change map, in which the required driving force and the vehicle speed are used as parameters to define a gear change timing, and a second gear change map, in which the required braking force and the vehicle speed are used as parameters to define a gear change timing that positively utilizes engine braking; and a management device that executes a gear change control of the automatic transmission based on an output from the vehicle speed sensor, the required driving force sensor, and the required braking force sensor, wherein
the management device collates an actual required driving force and the detected vehicle speed with the first gear change map in the storage device to execute the gear change control if a brake device is not actuated while the vehicle is in motion, and collates an actual required braking force and the detected actual vehicle speed with the second gear change map in the storage device to execute the gear change control if the brake device is actuated while the vehicle is in motion, wherein
the second gear change map has an upshift gear change line and a downshift gear change line for each gear, the upshift gear change line is shaped to permit an upshift at a higher vehicle speed as the required braking force increases and the downshift gear change line is shaped to permit a downshift at a higher vehicle speed as the brake required braking force increases.

5. A method of controlling an automatic transmission, comprising:
executing a gear change control of the automatic transmission based on a first gear change map, in which a required driving force and a vehicle speed are used as parameters to define a gear change timing, if a brake device is not actuated while the vehicle is in motion; and
executing the gear change control of the automatic transmission based on a second gear change map, in which a required braking force and the vehicle speed are used as parameters to define a gear change timing that positively utilizes engine braking, if the brake device is actuated while the vehicle is in motion, wherein
the second gear change map has an upshift gear change line and a downshift gear change line for each gear, the upshift gear change line is shaped to permit an upshift at a higher vehicle speed as the required braking force increases and the downshift gear change line is shaped to permit a downshift at a higher vehicle speed as the brake required braking force increases.

6. A control method for an automatic transmission comprising:
detecting a vehicle speed;
detecting a required driving force;
detecting a required braking force;
storing a first gear change map, in which the required driving force and the vehicle speed are used as parameters to define a gear change timing, and a second gear change map, in which the required braking force and the vehicle speed are used as parameters to define a gear change timing that positively utilizes engine braking;
executing a gear change control of the automatic transmission based on the detected vehicle speed, required driving force, and required braking force; and
collating an actual required driving force and an actual vehicle speed with the stored first gear change map to execute the gear change control of the automatic transmission if a brake device is not actuated while the vehicle is in motion, and collating the actual required driving force and the actual vehicle speed with the stored second gear change map to execute the gear change control of the automatic transmission if the brake device is actuated while the vehicle is in motion, wherein
the second gear change map has an upshift gear change line and a downshift gear change line for each gear, the upshift gear change line is shaped to permit an upshift at a higher vehicle speed as the required braking force increases and the downshift gear change line is shaped to permit a downshift at a higher vehicle speed as the brake required braking force increases.
